(19) United States
(12) Patent Application Publication
(10) Pub. No.: US 2019/0256705 A1
(43) Pub. Date: Aug. 22, 2019

(54) NETWORKING FLAME RETARDANT DYNAMIC CROSS-LINKED NETWORKS

(71) Applicant: SABIC GLOBAL TECHNOLOGIES B.V., Bergen op Zoom (NL)

(72) Inventors: Tony FARRELL, Bergen op Zoom (NL); Erik SCHWARTZ, Nijmegen (NL); Johannes Gerardus Petrus GOOSSENS, Heeswijk-Dinther (NL); Ramon GROOTE, Oisterwijk (NL); Sascha Jan TER HORST, Dordrecht (NL)

(21) Appl. No.: 16/334,045

(22) PCT Filed: Sep. 26, 2017
(86) PCT No.: PCT/IB2017/055866

§ 371 Date: Mar. 18, 2019

Related U.S. Application Data
(60) Provisional application No. 62/399,848, filed on Sep. 26, 2016.

(51) Int. Cl. C08L 67/02; C08K 5/00; C08K 5/5399; C08K 5/1515; C08K 5/136

(52) U.S. Cl. CPC C08L 67/02; C08K 5/0066; C08K 5/5399; C08K 7/02; C08K 5/136; C08L 2201/02; C08L 2312/00; C08K 5/1515

(57) ABSTRACT

Provided are pre-dynamically cross-linked compositions including a networking additive including a flame retardant species. Specifically, such compositions include a polymer component including a pre-dynamic cross-linked polymer composition. The pre-dynamic polymer composition includes polyester component chains joined by a coupler component, the coupler component including a flame retardant species. A method of preparing a dynamic cross-linked polymer composition includes: reacting a coupler component including at least two reactive groups and a flame retardant species with a chain component including a polyester. The reacting is performed under such conditions so as to form a pre-dynamic cross-linked composition, and is performed in the presence of at least one catalyst that promotes formation of the pre-dynamic cross-linked composition. The pre-dynamic cross-linked composition, when subjected to a curing process, exhibits certain plateau modulus characteristics and has the capability of relaxing internal residual stresses.

### FIELD OF THE DISCLOSURE

The present disclosure relates to dynamic cross-linked polymer compositions (DCNs) including a flame retardant, and specifically to polymer compositions including polyester component chains joined by a coupler component that includes a flame retardant species.

### BACKGROUND

“Dynamic cross-linked polymer compositions” (or DCNs) represent a versatile class of polymers. The compositions feature a system of covalently cross-linked polymer networks and can be characterized by the nature of their structure. At elevated temperatures, it is believed that the cross-links undergo transesterification reactions at such a rate that a flow-like behavior can be observed. Here, the polymer can be processed much like a viscoelastic thermoplastic. At lower temperatures, these dynamic cross-linked polymer compositions behave more like classic thermosets. As the rate of inter-chain transesterification slows down, the network becomes more rigid and static. The dynamic nature of their cross-links allows these polymers to be heated, reheated, and reformed, as the polymers maintain structural integrity under demanding conditions. There remains, however, a need in the art for efficient methods of preparing dynamic cross-linked polymer compositions comprising certain flame retardant additives.

### SUMMARY

The present disclosure addresses the need in the art for flame retardant dynamic cross-linked networks by providing, inter alia, compositions comprising: a pre-dynamic cross-linked polymer composition, wherein the pre-dynamic polymer composition comprises a polyester component chains joined by a coupler component. The coupler component comprises a flame retardant species. In some aspects the composition does not include an additional flame retardant component other than the flame retardant species included in the coupler component.

The present disclosure also provides methods of reacting a coupler component comprising a flame retardant species and at least two reactive groups with a chain component comprising a polyester. The reaction is performed under such conditions so as to form a pre-dynamic cross-linked composition and is performed in the presence of at least one catalyst that promotes the formation of the pre-dynamic cross-linked composition. The pre-dynamic cross-linked composition, when subjected to a curing process, exhibits a plateau modulus of from about 0.01 Megapascals (MPa) to about 1000 MPa, at a temperature above the melting temperature of the chain component as measured by dynamic mechanical analysis. In addition, the pre-dynamic cross-linked composition, when subjected to a curing process, exhibits the capability of relaxing internal residual stresses at a characteristic timescale of between 0.1 second and 100,000 seconds above the glass transition temperature of the chain (e.g., polyester) component, as measured by stress-relaxation rheology measurement.

The present disclosure also provides articles formed from the described polymer compositions. Further provided are methods of forming an article, comprising a dynamic cross-linked polymer composition comprising preparing a dynamic cross-linked polymer composition and subjecting the dynamic cross-linked polymer composition to a conventional polymer forming process, such as compression molding, profile extrusion, injection molding, or blow molding to form the article.

The above-described and other features are exemplified by the following drawings, detailed description, examples, and claims.

### BRIEF DESCRIPTION OF THE DRAWINGS

The following is a brief description of the drawings wherein like elements are numbered alike and which are exemplary of the various aspects described herein.

FIG. 1 depicts the storage (solid line) and loss (dashed line) modulus of the oscillatory time sweep measurement curves for a cross-linked polymer network.

FIG. 2 depicts the normalized modulus (G/G₀) for the dynamically cross-linked polymer network (solid line), as well as a line representing the absence of stress relaxation in a conventionally cross-linked polymer network (dashed line, fictive data).

FIG. 3 depicts, in a qualitative fashion, the storage modulus qualities of DCN (curves B and C) and non-DCN (curve A) materials.

FIG. 4 shows Table 1 exemplary and comparative compositions of the present disclosure.

FIG. 5 shows Table 2 for further exemplary and comparative compositions of the present disclosure.

FIG. 6 shows Table 3 for a further exemplary composition of the present disclosure.

FIG. 7 shows Table 4 for further exemplary compositions of the present disclosure.

FIG. 8 shows Table 5 for further exemplary compositions of the present disclosure.

### DETAILED DESCRIPTION OF ILLUSTRATIVE EMBODIMENTS

The present disclosure may be understood more readily by reference to the following detailed description of desired aspects and the examples included therein. In the following specification and the claims that follow, reference will be made to a number of terms that have the following meanings.

Described herein are, inter alia, methods of making compositions, i.e., dynamic cross-linked polymer compositions. These compositions are advantageous because they can be prepared more readily than dynamic cross-linked or cross-linkable polymer compositions previously described in the art.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise. As used in the specification and in the claims, the term “comprising” may include the aspects “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Numerical values in the specification and claims of this application, particularly as they relate to polymers or polymer compositions, oligomers or oligomer compositions, reflect average values for a composition that may contain individual polymers or oligomers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein, “Tm” refers to the melting point at which a polymer, or oligomer, completely loses its orderly arrangement. As used herein, “Tc” refers to the polymer's crystallization temperature. The terms “Glass Transition Temperature” or “Tg” refer to the maximum temperature at which a polymer will still have one or more useful properties. These properties include impact resistance, stiffness, strength, and shape retention. The Tg therefore may be an indicator of its useful upper temperature limit, particularly in plastics applications. The Tg may be measured using a differential scanning calorimetry method and expressed in degrees Celsius (° C.).

As used herein, “cross-link,” and its variants, refer to the formation of a stable covalent bond between two polymer chains. This term is intended to encompass the formation of covalent bonds that result in network formation. The term “cross-linkable” refers to the ability of a polymer to form such stable covalent bonds.

As used herein, “pre-dynamic cross-linked polymer composition” refers to a mixture comprising all the required elements to form a dynamic cross-linked polymer composition, but which has not been cured sufficiently to establish the requisite level of cross-linking for forming a dynamic cross-linked polymer composition. Upon sufficient curing, for example, heating to temperatures up to about 320° C., a pre-dynamic cross-linked polymer composition may convert to a dynamic cross-linked polymer composition. In some aspects, sufficient curing may occur, for example, by heating to a temperature between 150° C. and 270° C. to convert the pre-dynamic cross-linked polymer composition to a dynamic cross-linked polymer composition. Pre-dynamic cross-linked polymer compositions may comprise a coupler component and a chain (in some aspects, the chain comprising a polyester) component. A coupler component may comprise at least two reactive groups, e.g., two, three, four, or even more reactive groups. Suitable reactive groups include, e.g., epoxy/epoxide groups, anhydride groups, glycerol and/or glycerol derivative groups, and the like. A coupler component may act to cross-link polymer chains, e.g., to cross-link polyester chains. A coupler component may also act as a chain extender. In further aspects, all reactive groups may be consumed in the formation of the dynamic cross-linked polymer composition. In certain aspects, some residual reactive groups (e.g., unreacted epoxy groups) of the coupler component may remain in the formed pre-dynamic cross-linked polymer composition.

A pre-dynamic cross-linked composition may in some aspects comprise a polymer component comprising a pre-dynamic cross-linked polymer composition, wherein the pre-dynamic polymer composition comprises polyester component chains linked by a coupler component that comprises a flame retardant species. The pre-dynamic cross-linked composition may be formed in the presence of a suitable catalyst. The pre-dynamic cross-linked polymer compositions may also comprise optional additives. In a specific example, the pre-dynamic cross-linked polymer compositions described herein may comprise a coupler component and a polyester component reacted in the presence of one or more catalysts. The pre-dynamic composition may also comprise one or more additional additives, e.g., fillers such as glass fiber (or other fibers) or talc.

As used herein, “dynamic cross-linked polymer composition” refers to a class of polymer systems that include dynamically, covalently cross-linked polymer networks. At low temperatures, dynamic cross-linked polymer compositions behave like classic thermosets, but at higher temperatures, for example, temperatures up to about 320° C., or more specifically between about 150° C. to about 270° C., it is theorized that the cross-links have dynamic mobility, resulting in a flow-like behavior that enables the composition to be processed and re-processed. Dynamic cross-linked polymer compositions incorporate covalently cross-linked networks that are able to change their topology through thermo-activated bond exchange reactions. The network is capable of reorganizing itself without altering the number of cross-links between its chains of chain segments. At high temperatures, dynamic cross-linked polymer compositions achieve transesterification rates that permit mobility between cross-links, so that the network behaves like a flexible rubber. At low temperatures, exchange reactions are very slow and dynamic cross-linked polymer compositions behave like classic thermosets. Put another way, dynamic cross-linked polymer compositions can be heated to temperatures such that they become liquid without suffering destruction or degradation of their structure. The viscosity of these materials varies slowly over a broad temperature range, with behavior that approaches the Arrhenius law. The cross-links are capable of rearranging themselves via bond exchange reactions between multiple cross-links and/or chain segments as described, for example, by Kloxin and Bowman, Chem. Soc. Rev. 2013, 42, 7161-7173, the disclosure of which is incorporated by this reference herein in its entirety. The continuous rearrangement reactions may occur at room or elevated temperatures depending upon the dynamic covalent chemistry applicable to the system. The respective degree of cross-linking may depend on temperature and stoichiometry.

Dynamic cross-linked polymer compositions of the disclosure can have Tg of about 40° C. to about 60° C. Articles in accordance with the present disclosure may comprise a shape generated by applying mechanical forces to a molded piece formed from the dynamic cross-linked polymer composition. This combination of properties permits the manufacture of shapes that are difficult or impossible to obtain by molding or for which making a mold would not be economical. Dynamic cross-linked polymer compositions generally have good mechanical strength at low temperatures, high chemical resistance, and low coefficient of thermal expansion, along with processability at high temperatures. Examples of dynamic cross-linked polymer compositions are described herein, as well as in U.S. Patent Application No. 2011/0319524, WO 2012/152859; WO 2014/086974; D. Montarnal et al., Science 334 (2011) 965-968; and J.P. Brutman et al, ACS Macro Lett. 2014, 3, 607-610, the disclosures of which are incorporated by this reference herein in their entirety.

Examining the nature of a given polymer composition can distinguish whether the composition is cross-linked, reversibly cross-linked, or non-cross-linked, and distinguish whether the composition is conventionally cross-linked or dynamically cross-linked. A dynamically cross-linked composition typically remains cross-linked at all times, provided the chemical equilibrium allowing cross-linking is maintained. A reversibly cross-linked network however shows network dissociation upon heating, reversibly transforming to a low-viscous liquid and then reforming the cross-linked network upon cooling. Reversibly cross-linked compositions also tend to dissociate in solvents, particularly polar solvents, while dynamically cross-linked compositions tend to swell in solvents as do conventionally cross-linked compositions.

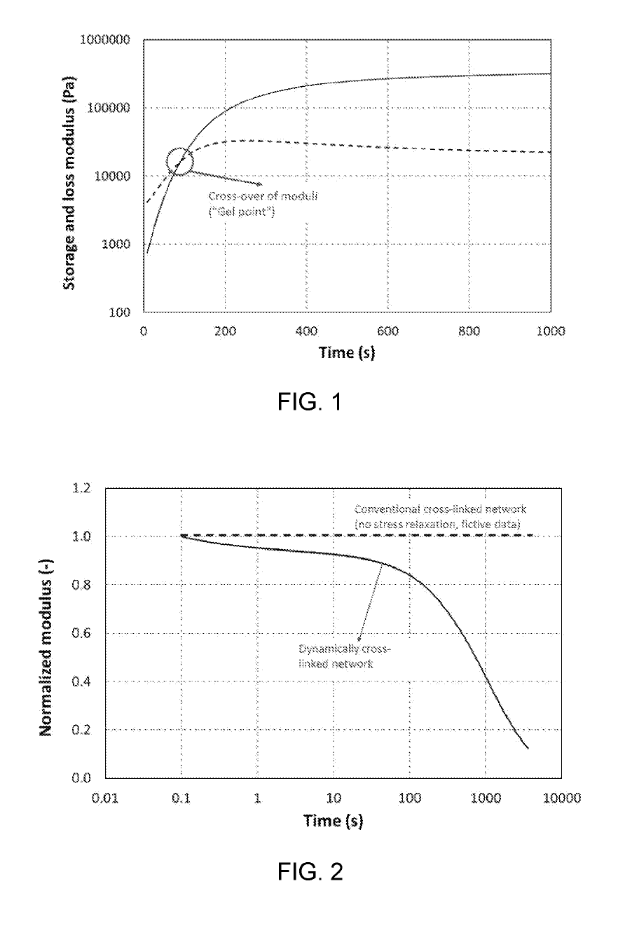

The cross-linked network apparent in dynamic and other conventionally cross-linked systems may also be identified by rheological testing. An oscillatory time sweep (OTS) measurement at fixed strain and temperature may be used to confirm network formation. Exemplary OTS curves are presented in FIG. 1 for a cross-linked polymer network.

A curve may indicate whether or not the polymer has a cross-linked network.

Initially, the loss modulus (viscous component) has a greater value than the storage modulus (elastic component) indicating that the material behaves like a viscous liquid. Polymer network formation is evidenced by the intersection of the loss and storage modulus curves. The intersection, referred to as the “gel point,” represents when the elastic component predominates the viscous component and the polymer begins to behave like an elastic solid.

In distinguishing between dynamic cross-linking and conventional (or non-reversible) cross-linking, a stress-relaxation measurement may also, or alternatively, be performed at constant strain and temperature.

After network formation, the polymer may be heated and a certain strain is imposed on the polymer. After removing the strain, the resulting evolution of the elastic modulus as a function of time reveals whether the polymer is dynamically or conventionally cross-linked. Exemplary curves for dynamically and conventionally cross-linked polymer networks are presented in FIG. 2.

Stress relaxation generally follows a multimodal behavior:

$$G \text{/} {G}_{0} = {\sum }_{i = 1}^{n} {C}_{i} exp ( - t \text{/} {τ}_{i} ) ,$$

where the number (n), relative contribution (Cᵢ) and characteristic timescales (τ i) of the different relaxation modes are governed by bond exchange chemistry, network topology and network density. For conventionally cross-linked networks, relaxation times approach infinity, τ→∞, and G/G₀=1 (horizontal dashed line). Apparent in the curves for the normalized modulus (G/G₀) as a function of time, a conventionally cross-linked network does not exhibit any stress relaxation because the permanent character of the cross-links prevents the polymer chain segments from moving with respect to one another. A dynamically cross-linked network, however, features bond exchange reactions allowing for individual movement of polymer chain segments thereby allowing for complete stress relaxation over time.

If the networks are DCNs, they should be able to relax any residual stress that is imposed on the material as a result of network rearrangement at higher temperature. In simplified DCN systems, the relaxation of residual stresses with time can be described with single-exponential decay function, having the characteristic relaxation time τ*:

$$G ( t ) = G ( 0 ) \times exp ( - \frac{t}{{τ}^{*}} )$$

A characteristic relaxation time can be defined as the time needed to attain particular G(t)/G(0) at a given temperature. It should be noted that some DCN systems could have multimode behavior with multiple relaxation times. At lower temperature, the stress relaxes slower, while at elevated temperature network rearrangement becomes more active and hence the stress relaxes faster, proving the dynamic nature of the network. The influence of temperature on the stress relaxation modulus clearly demonstrates the ability of the cross-linked network to relieve stress or flow as a function of temperature.

Additionally, the influence of temperature on the stress relaxation rate in correspondence with transesterification rate were investigated by fitting the characteristic relaxation time, τ* to an Arrhenius type equation.

ln τ*=−Eₐ/RT+ln A

where Eₐ is the activation energy for the transesterification reaction.

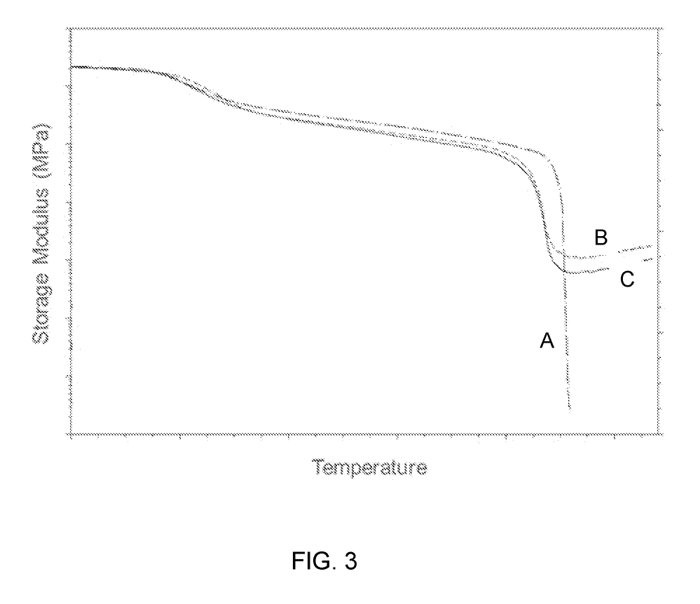

Generally, a dynamic mechanical analysis (DMA) of storage modulus as a function of temperature may exhibit particular informative characteristics. A dynamically cross-linked polymer composition may exhibit a plateau modulus of from about 0.01 MPa to about 1000 MPa, at a temperature above the melting temperature (and, depending on the polymer, above the glass transition temperature) of the polyester component. Non-limiting FIG. 3 provides a set of exemplary, qualitative curves for a representative polybutylene terephthalate (PBT) polymer. Two of the three curves (curves B and C) exhibit a plateau modulus above a certain temperature, thus depicting a dynamically cross-linked network. One of the three curves (curve A), instead of showing a plateau modulus above a certain temperature, exhibits an abrupt decline in modulus at the elevated temperature. Thus, curve A provides a qualitative depiction of a non-dynamically cross-linked polymer composition. For thermoplastic materials with a high (or higher) entanglement density, similar curves as B and C can be observed.

A pre-dynamic cross-linked composition, formed according to the present disclosure described herein, when subjected to a curing process may exhibit a plateau modulus of from about 0.01 MPa to about 1000 MPa, at a temperature above the melting temperature (and, depending on the polymer, above the glass transition temperature) of the polyester component as measured by dynamic mechanical analysis. The cured pre-dynamic cross-linked polymer composition may further exhibit the capability of relaxing internal residual stresses at a characteristic timescale of between 0.1 and 100,000 seconds (s) above the glass transition temperature of the polyester component, as measured by stress-relaxation rheology measurement. It should be understood that in the case of some polymers, (including some semi-crystalline polymers, e.g., polybutylene terephthalate (PBT)) the cured pre-dynamic cross-linked polymer composition may further exhibit the capability of relaxing internal residual stresses at a characteristic timescale of between 0.1 and 100,000 seconds above the Tm for that polymer.

Described herein are pre-dynamic cross-linked polymer compositions and methods of making thereof. Further described are dynamic cross-linked polymer compositions formed from the pre-dynamic cross-linked polymer compositions.

Described herein are methods of preparing dynamic cross-linked polymer compositions that include one or more non-networking additives. According to these methods, a coupler component (that includes a flame retardant species) and a polyester component are reacted in the presence of one or more catalysts; a non-networking additive is also suitably added. The resulting pre-dynamically cross-linked polymer composition may be subjected to a curing process to form a cured dynamically cross-linked polymer composition.

Described herein are methods of preparing dynamic cross-linked polymer compositions including one or more non-networking additives. In one aspect, a coupler component comprising a flame retardant species and at least two epoxy (or other reactive) groups and a chain component comprising a polyester may be reacted. One or more additional, non-networking additives may also be added. The reaction may be performed under such conditions so as to form a pre-dynamic cross-linked composition. The reaction may also be performed in the presence of at least one catalyst that promotes the formation of the pre-dynamic cross-linked composition. According to these methods, a coupler component, a polyester component, a non-networking additive, and a catalyst may be reacted or combined at temperature of up to about 320° C. for about 15 minutes (min) or fewer.

In certain aspects, the reaction may occur for less than about 7 minutes so as to form the pre-dynamic cross-linked polymer composition. In other aspects, the reaction occurs for less than about 4 minutes. In yet other aspects, the reaction occurs for less than about 2.5 minutes. In still other aspects, the reaction occurs for between about 10 minutes and about 15 minutes.

In some aspects, the reaction occurs at temperatures of up to about 320° C. to form the pre-dynamic cross-linked polymer composition. In yet other aspects, the reaction may occur at temperatures between about 40° C. and about 320° C. In other aspects, the reaction occurs at temperatures between about 40° C. and about 290° C. In some aspects, the reaction occurs at temperatures between about 40° C. and about 280° C. In some aspects, the reaction occurs at temperatures between about 40° C. and about 270° C. In still other aspects, the reaction occurs at temperatures between about 70° C. and about 270° C. In other aspects, the combining step occurs at temperatures between about 70° C. and about 240° C. In still other aspects, the reaction occurs at temperatures between about 190° C. and about 270° C.

In some aspects of the present disclosure, the reaction occurs at a temperature that is less than the temperature of degradation of the chain or polyester component. That is, the reaction may occur at a temperature at which the polyester component is in a melted state. As one example, the reaction occurs at a temperature less than or about equal to the Tm of the respective polyester. In one example, where the polyester component is PBT, the reaction step may occur at about 240° C. to 260° C., below the degradation temperature of PBT.

The reaction step so as to form a pre-dynamic cross-linked polymer composition can be achieved using any means known in the art, for example, mixing, including screw mixing, blending, stirring, shaking, and the like. One approach for combining the coupler component, the polyester component, the non-networking additive, and the one or more catalysts is to use an extruder apparatus, for example, a single screw or twin screw extruding apparatus. In a specific example, the foregoing components may be compounded. The reaction may be performed in a reactor vessel (stirred or otherwise), and may also be performed as a reactive extrusion.

The methods described herein may be carried out under ambient atmospheric conditions, but it is preferred that the methods be carried out under an inert atmosphere, for example, a nitrogen atmosphere. In a certain aspect, the methods may be carried out under conditions that reduce the amount of moisture in the resulting pre-dynamic cross-linked polymer compositions described herein. For example, a pre-dynamic cross-linked polymer compositions described herein may have less than about 3.0 wt %, less than about 2.5 wt %, less than about 2.0 wt %, less than about 1.5 wt %, or less than about 1.0 wt % of water (i.e., moisture), based on the weight of the pre-dynamic cross-linked polymer composition.

In some methods, the combination of the coupler component, the polyester component, the non-networking additive, and the one or more catalysts is carried out at atmospheric pressure. In other aspects, the combining step can be carried out at a pressure that is less than atmospheric pressure. For example, in some aspects, the combination of the coupler component, the polyester component, the one or more non-networking additive, and the catalyst is carried out in a vacuum.

The compositions of the present disclosure provide dynamically cross-linked compositions exhibiting the characteristic stress relaxation behavior associated with the formation of a dynamic network. In certain aspects of the present disclosure, to achieve a fully cured, dynamic cross-linked composition, pre-dynamic cross-linked polymer compositions prepared herein undergo a post-curing step. The post-curing step may include heating the obtained composition to elevated temperatures for a prolonged period. The composition may be heated to a temperature just below its melt or deformation temperature. Heating to just below the melt or deformation temperature of the polyester component may activate the dynamically cross-linked network, thereby, curing the composition to a dynamic cross-linked polymer composition.

A post-curing step may be applied to activate the dynamic cross-linked network in certain compositions of the present disclosure; formation of a dynamic cross-linked network when using certain coupler components may be facilitated with a post-curing step is performed to facilitate the formation of the dynamically cross-linked network. For example, a post-curing step may be used for a composition prepared with a less reactive coupler component. Less reactive coupler components may include epoxy chain extenders that generate secondary alcohols in the presence of a suitable catalyst.

In yet further aspects of the present disclosure, certain compositions exhibit dynamic cross-linked network formation after a shorter post-curing step. As an example, a pre-dynamic cross-linked polymer composition prepared with a bisphenol A diglycidyl ether (BADGE) and a cycloaliphatic epoxy (ERL) as the coupler component may require a post-curing step to establish a dynamically cross-linked network in the final product.

In yet further aspects, compositions assume a dynamically cross-linked network formation and need not undergo a post-curing step. That is, these compositions do not require additional heating to achieve the dynamically cross-linked network. In some aspects, compositions derived from more reactive chain extenders exhibit dynamically cross-linked network behavior without heating. More reactive chain extenders can include epoxy chain extenders that generate primary alcohols in the presence of a suitable catalyst.

As described herein, the pre-dynamic cross-linked polymer composition may be subjected to a curing process to provide a dynamic cross-linked polymer composition. The curing process may comprise heating the pre-dynamic cross-linked composition of from a temperature that corresponds to the glass transition temperature (Tg) of the composition to a temperature of about 250° C. In particular aspects the curing process may comprise heating the pre-dynamic cross-linked composition to a temperature between about 170° C. to about 250° C. The pre-dynamic cross-linked polymer composition may be heated for a duration of up to about 8 hours.

The pre-dynamic (or after curing, the dynamic) cross-linked polymer compositions can be formed into any shape known in the art. Such shapes can be convenient for transporting the dynamic cross-linked polymer compositions described herein. Alternatively, the shapes can be useful in the further processing of the pre-dynamic cross-linked polymer compositions described herein into dynamic cross-linked polymer compositions and articles comprising them. For example, the pre-dynamic cross-linked polymer compositions can be formed into pellets. In other aspects, the pre-dynamic cross-linked polymer compositions can be formed into flakes. In yet other aspects, the pre-dynamic cross-linked polymer compositions can be formed into powders. In some aspects, cured dynamic cross-linked pellets may be re-compounded with additional amounts of the polyester component comprising desired additives.

The pre-dynamic and dynamic cross-linked polymer compositions described herein can be used in conventional polymer forming processes such as injection molding, compression molding, profile extrusion, and blow molding. For example, the pre-dynamic cross-linked polymer compositions prepared according to the described methods can be melted and then injected into a mold to form an injection-molded article. The injection-molded article can then be cured by heating to temperatures of up to about 270° C., followed by cooling to ambient temperature. As an example, articles may be formed from the dynamic cross-linked polymer compositions of the present disclosure and may include composites, a thermoformed material, or a combination thereof.

Alternatively, the pre-dynamic cross-linked polymer compositions described herein can be melted, subjected to compression molding processes, and then cured. In other aspects, the pre-dynamic cross-linked polymer compositions described herein can be melted, subjected to profile extrusion processes, and then cured. In some aspects, the dynamic cross-linked polymer compositions described herein can be melted, subjected to blow molding processes, and then cured. The individual components of the pre-dynamic cross-linked polymer compositions are described in more detail herein.

### Polyester Chain Component

Present in the compositions described herein are polymers that have ester linkages, i.e., polyesters. The polymer can be a polyester that includes ester linkages between monomers. The polymer can also be a copolyester, which is a copolymer comprising ester and other linkages and diacids.

The polymer having ester linkages can be a polyalkylene terephthalate, for example, poly(butylene terephthalate), also known as PBT, which has the structure shown below:

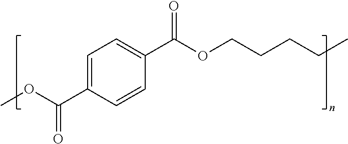

where n is the degree of polymerization, and can have a value as high as 1,000. The polymer may have a weight average molecular weight of up to 100,000 grams per mole (g/mol).

The polymer having ester linkages can be an oligomer containing ethylene terephthalate units which has the structure shown below:

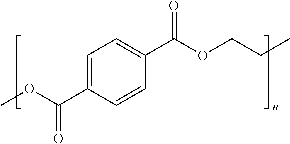

where n is the degree of polymerization, and can have a value up to 1000. The ethylene terephthalate oligomer may have a molecular weight of up to about 100,000 g/mol.

The polymer having ester linkages can be PCTG, which refers to poly(cyclohexylenedimethylene terephthalate), glycol-modified. This is a copolymer formed from 1,4-cyclohexanedimethanol (CHDM), ethylene glycol, and terephthalic acid. The two diols react with the diacid to form a copolyester. The resulting copolyester has the structure shown below:

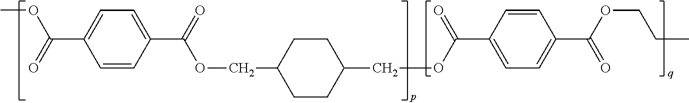

where p is the molar percentage of repeating units derived from CHDM, q is the molar percentage of repeating units derived from ethylene glycol, and p>q, and the polymer may have a weight average molecular weight of up to 100,000.

The polyester having ester linkages can also be ETG polyester. ETG-oligomer has the same structure as CTG-oligomer, except that the ethylene glycol is 50 mole % or more of the diol content. ETG polyester is an abbreviation for a polyester containing ethylene terephthalate, glycol-modified. In some aspects, the polymer having ester linkages can be poly(1,4-cyclohexane-dimethanol-1,4-cyclohexanedicarboxylate), i.e. PCCD, which is a polyester formed from the reaction of CHDM with dimethyl cyclohexane-1,4-dicarboxylate. PCCD has the structure shown below:

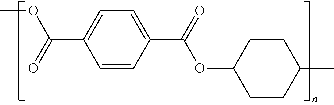

where n is the degree of polymerization, and can be as high as 1,000, and the polymer may have a weight average molecular weight of up to 100,000 g/mol.

The polymer having ester linkages can be poly(ethylene naphthalate), also known as PEN, which has the structure shown below:

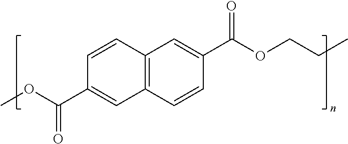

where n is the degree of polymerization, and can be as high as 1,000, and the polymer may have a weight average molecular weight of up to 100,000 g/mol.

The polymer having ester linkages can also be a copolyestercarbonate. A copolyestercarbonate contains two sets of repeating units, one having carbonate linkages and the other having ester linkages. This is illustrated in the structure below:

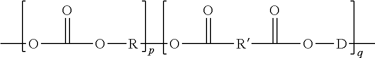

where p is the molar percentage of repeating units having carbonate linkages, q is the molar percentage of repeating units having ester linkages, and p+q=100%; and R, R′, and D are independently divalent radicals.

The divalent radicals R, R′ and D can be made from any combination of aliphatic or aromatic radicals, and can also contain other heteroatoms, such as for example oxygen, sulfur, or halogen. R and D are generally derived from dihydroxy compounds, such as the bisphenols of Formula (A). In particular aspects, R is derived from bisphenol-A. R′ is generally derived from a dicarboxylic acid. Exemplary dicarboxylic acids include isophthalic acid, terephthalic acid. 1,2-di(p-carboxyphenyl)ethane, 4,4′-dicarboxydiphenyl ether, 4,4′-bisbenzoic acid, 1,4-, 1,5-, or 2,6-naphthalenedicarboxylic acids, and cyclohexane dicarboxylic acid. As additional examples, the repeating unit having ester linkages could be butylene terephthalate, ethylene terephthalate, PCCD, or ethylene naphthalate as depicted above.

Aliphatic polyesters can also be used. Examples of aliphatic polyesters include polyesters having repeating units of the following formula:

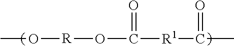

where at least one R or R¹ is an alkyl-containing radical. They are prepared from the polycondensation of glycol and aliphatic dicarboxylic acids.

By using an equimolar ratio between the hydroxyl/epoxy groups of the epoxy-containing component and the ester groups of the polymer having ester linkages, a moderately cross-linked polyhydroxy ester network can be obtained. The following conditions are generally sufficient to obtain a three-dimensional network:

N_{A}<N_{O}+2N_{X}

N_{A}>N_{X}

wherein N_{O} denotes the number of moles of hydroxyl groups; N_{X} denotes the number of moles of epoxy groups; and N_{A} denotes the number of moles of ester groups.

In one example, with the coupler component comprising at least two epoxy groups, the mole ratio of hydroxyl/epoxy groups (from the coupler epoxy-containing component) to the ester groups (from the polymer having ester linkages or the polyester component) in the system is generally from about 1:100 to about 5 to 100.

The pre-dynamic cross-linked polymer compositions of the present disclosure include a polyester component, e.g., an ester oligomer or polybutylene terephthalate (PBT). The polyester component may be present at, e.g., from 10 wt % to 95 wt % or from about 10 wt % to about 95 wt % measured against the total weight of the pre-dynamic cross-linked composition.

### Coupler Component

The compositions of the present disclosure suitably include a coupler component. In various aspects, the coupler component may function as chain extender or a cross-linking agent. In an aspect, the coupler component can be functional, that is, the component may exhibit reactivity with one or more groups of a given chemical structure. As an example, the coupler component described herein may be characterized by one of two reactivities with groups present within the ester oligomer component, i.e., a polyester-comprising chain component. The coupler component may react with 1) a carboxylic acid end group moiety of the chain component or 2) an alcohol end group moiety of the chain component. As described elsewhere herein, a coupler component suitably includes at least two reactive groups; exemplary such reactive groups include epoxy, anhydride, and glycerol/glycerol derivatives. In one example, the coupler component of the present disclosure may comprise at least two epoxy groups. Although many of the non-limiting examples provided herein present epoxy-including coupler components, it should be understood that these examples do not limit the scope of coupler components to coupler components that include only epoxy groups. The coupler component suitably comprises a flame retardant species, as described elsewhere herein. In some aspects the composition does not include an additional flame retardant component other than the flame retardant species included in the coupler component. In particular, in some aspects the composition does not include a halogenated flame retardant component.

A coupler component may be a monomer, an oligomer, or a polymer. In an aspect, the coupler component may be multi-functional, that is having at least two epoxy groups. Generally, the epoxy-containing component has at least two epoxy groups, and can also include other functional groups as desired, for example, hydroxyl (—OH) groups. Glycidyl epoxy resins are a particularly preferred epoxy-containing component. In further aspects, the epoxy-containing component may have three, four, five, or more epoxy groups.

A coupler component may comprise a monomeric compound exhibiting reactivity with the carboxylic groups of the polyester component. These monomeric compounds may include e.g., epoxy based compounds. Anhydride and glycerol/glycerol derivative compounds are also suitable. Various epoxy coupler components and their content in the pre-dynamic composition may largely affect the networks' property by affecting the cross-link density and transesterification dynamics. The epoxy moiety of a coupler component may directly react with the carboxylic acid end group of the polyester component in the presence of the one or more catalysts. In an aspect, an epoxy-containing coupler component may be multi-functional, that is having at least two epoxy groups. The coupler component generally has at least two epoxy groups, and can also include other functional groups as desired, for example, hydroxyl (—OH). Glycidyl epoxy resins are a particular coupler component.

One exemplary glycidyl epoxy ether is bisphenol A diglycidyl ether (BADGE), which can be considered a monomer, oligomer or a polymer, and is shown below as Formula (A):

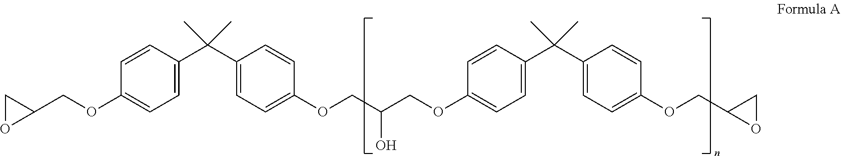

The value of n may be from 0 to 25 in Formula (A). When n=0, this is a monomer. When n=1 to 7, this is an oligomer. When n=8 to 25, this is a polymer. BADGE-based resins have excellent electrical properties, low shrinkage, good adhesion to numerous metals, good moisture resistance, good heat resistance and good resistance to mechanical impacts. BADGE oligomers (where n=1 or 2) are commercially available as D.E.R.™ 671 from Dow, which has an epoxide equivalent of 475-550 grams/equivalent, 7.8-9.4% epoxide, 1820-2110 mmol of epoxide/kilogram, a melt viscosity at 150° C. of 400-950 milliPascal seconds (mPa·sec), and a softening point of 75-85° C.

Novolac resins can be used as the coupler component. The epoxy resins are obtained by reacting phenol with formaldehyde in the presence of an acid catalyst to produce a novolac phenolic resin, followed by a reaction with epichlorohydrin in the presence of sodium hydroxide as catalyst. Epoxy resins are illustrated as Formula (B):

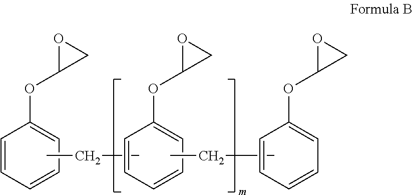

wherein m is a value from 0 to 25.

Another useful coupler component comprising at least two epoxy groups is depicted in Formula C, a cycloaliphatic epoxy (ERL).

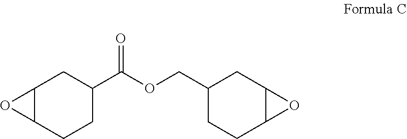 [SMILES: O=C(OCC1CCC2OC2C1)C1CCC2OC2C1]

For a monomeric bisphenol A epoxy, the value of n is 0 in Formula (A). When n=0, this is a monomer. BADGE-based resins have excellent electrical properties, low shrinkage, good adhesion to numerous metals, good moisture resistance, good heat resistance and good resistance to mechanical impacts. In some aspects of the present disclosure, the BADGE has a molecular weight of about 1000 Daltons and an epoxy equivalent of about 530 grams (g) per equivalent. As used herein, the epoxy equivalent is an expression of the epoxide content of a given compound. The epoxy equivalent is the number of epoxide equivalents in 1 g of resin (eq./g).

Exemplary coupler components of the present disclosure include monomeric epoxy compounds which generate a primary alcohol. In the presence of a suitable catalyst, the generated primary alcohol can readily undergo transesterification. As an example, and not to be limiting, exemplary coupler components that generate a primary alcohol include certain cyclic epoxies. Exemplary cyclic epoxies that generate a primary alcohol in the presence of a suitable catalyst have a structure according to Formula D.

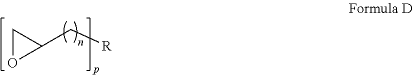

where n is greater than or equal to 1 and R can be any chemical group (including, but not limited to, ether, ester, phenyl, alkyl, alkynyl, etc.). In preferred aspects of the present disclosure, p is greater than or equal to 2 such that there are at least 2 of the epoxy structural groups present in the chain extender molecular. BADGE is an exemplary epoxy chain extender where R is bisphenol A, n is 1, and p is 2.

Other exemplary monomeric epoxy chain extenders include diglycidyl benzenedicarboxylate (Formula E) and triglycidyl benzene tricarboxylate (Formula F).

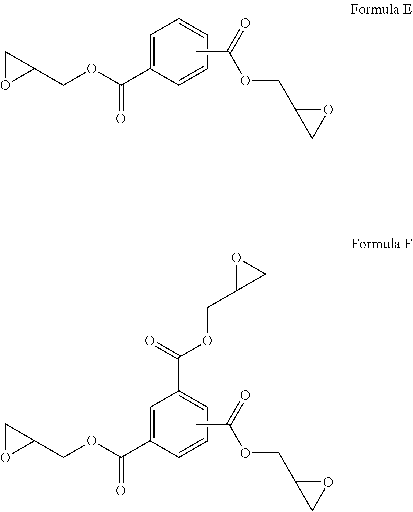

As noted herein, the coupler component is suitably reactive with the alcohol moiety present in the polyester chain component. Such coupler components may include a dianhydride compound, such as a monomeric dianhydride compound. The dianhydride compound facilitates network formation by undergoing direct esterification with the ester oligomer. In the presence of a suitable catalyst, the dianhydride can undergo ring opening, thereby generating carboxylic acid groups. The generated carboxylic acid groups undergo direct esterification with the alcohol groups of the polyester component.

An exemplary class of a monomeric coupler component that is reactive with the alcohol moiety present in the ester oligomer includes dianhydrides. A preferred dianhydride is a pyromellitic dianhydride as provided in Formula G.

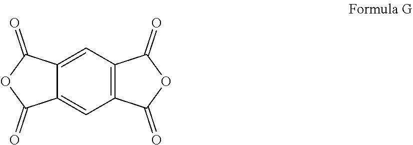 [SMILES: O=c1oc(=O)c2cc3c(=O)oc(=O)c3cc12]

As explained herein, the coupler component may comprise a polymeric composition. For example, the coupler component may comprise a component exhibiting reactivity with the carboxylic groups of the polyester component. These coupler components may include chain extenders having high epoxy functionality. High epoxy functionality can be characterized by the presence of between 200 and 300 equivalent per mol (eq/mol) of glycidyl epoxy groups.

An epoxidized styrene-acrylic copolymer, CESA, represents an exemplary polymeric coupler component. CESA is a copolymer of styrene, methyl methacrylate, and glycidyl methacrylate.

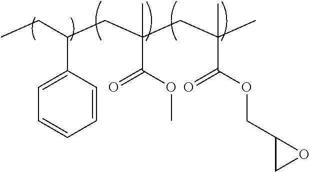

A preferred CESA according to the methods of the present disclosure has average molecular weight of about 6800 g/mol and an epoxy equivalent of 280 g/mol. As used herein, the epoxy equivalent is an expression of the epoxide content of a given compound. The epoxy equivalent is the number of epoxide equivalents in 1 kg of resin (eq./g).

According to various aspects of the present disclosure, the coupler component may comprise a flame retardant species in addition to the at least two epoxy groups. The coupler component may comprise a flame retardant modified epoxy species. For example, the coupler component may comprise organophosphorus or organobromo modified (or functionalized) flame retardant species. The coupler component comprising the flame retardant species reacts in the formation of the cross-linked network of the pre-dynamically cross-linked polymer composition.

In some aspects, the coupler component may comprise an organophosphorus functionalized epoxy composition, wherein the organophosphorus moiety (or moieties) performs as a flame retardant species. Here, the particular organophosphorus-modified epoxy compound acts as a network forming additive as well as a flame retardant. A general representation of such a component is illustrated below.

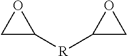

In particular, the R block may correspond to the organophosphorus moiety and may include phosphazenes, phosphates (P(═O)(OR)₃), phosphites (P(OR)₃), phosphonate (RP(═O)(OR)₂), phosphinate (R₂P(═O)(OR)), phosphine oxide (R₃P(═O)), or phosphine (R₃P), or a functionalized (end or side chain) polymeric or oligomer organophosphate according to any of the aforementioned organophosphorus compounds. Each R in the foregoing phosphorus-containing groups can be the same or different, provided that at least one R is an aromatic group. A combination of different phosphorus-containing groups can be used. The aromatic group can be directly or indirectly bonded to the phosphorus, or to an oxygen of the phosphorus-containing group (i.e., an ester). As noted herein, epoxy functionality may be at least two per coupler component.

Accordingly, depending on the particular organophosphorus compound used, the pre-dynamically cross-linked compositions may comprise up to about 20 wt % of the coupler component (or the product of the reaction of that coupler component with the polyester component) comprising the organophosphorus flame retardant species based on the total weight of the composition.

In one aspect, the coupler component may comprise an aromatic organophosphorus flame retardant species. The aromatic organophosphorus flame retardant species may be a monomeric phosphate. Representative monomeric aromatic phosphates are of the formula (GO)₃P═O, wherein each G is independently an alkyl, cycloalkyl, aryl, alkylarylene, or arylalkylene group having up to 30 carbon atoms, provided that at least one G is an aromatic group. Two of the G groups can be joined together to provide a cyclic group. In some aspects G corresponds to a monomer, e.g., resorcinol. Exemplary phosphates include phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like. A specific aromatic phosphate is one in which each G is aromatic, for example, triphenyl phosphate, tricresyl phosphate, isopropylated triphenyl phosphate, and the like.

Di- or polyfunctional aromatic phosphorus-containing compounds are also useful, for example, compounds of Formula H:

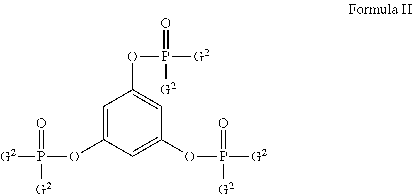

Specific aromatic organophosphorus compounds have two or more phosphorus-containing groups, and are inclusive of acid esters of Formula I:

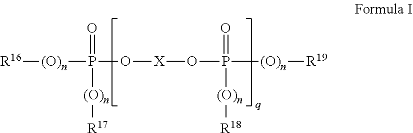

wherein R¹⁶, R¹⁷, R¹⁸, and R¹⁹ are each independently C₁₋₈ alkyl, C₅₋₆ cycloalkyl, C₆₋₂₀ aryl, or C₇₋₁₂ arylalkylene, each optionally substituted by C₁₋₁₂ alkyl, specifically by C₁₋₄ alkyl and X is a mono- or poly-nuclear aromatic C₆₋₃₀ moiety or a linear or branched C₂₋₃₀ aliphatic radical, which can be OH-substituted and can contain up to 8 ether bonds, provided that at least one of R¹⁶, R¹⁷, R¹⁸, R¹⁹, and X is an aromatic group. In some aspects R¹⁶, R¹⁷, R¹⁸, and R¹⁹ are each independently C₁₋₄ alkyl, naphthyl, phenyl(C₁₋₄)alkylene, or aryl groups optionally substituted by C₁₋₄ alkyl. Specific aryl moieties are cresyl, phenyl, xylenyl, propylphenyl, or butylphenyl. In some aspects X in Formula I is a mono- or poly-nuclear aromatic C₆₋₃₀ moiety derived from a diphenol. Further in Formula I, n is each independently 0 or 1; in some aspects n is equal to 1. Also in Formula I, q is from 0.5 to 30, from 0.8 to 15, from 1 to 5, or from 1 to 2. Specifically, X can be represented by the following divalent groups (Formula J), or a combination comprising one or more of these divalent groups,

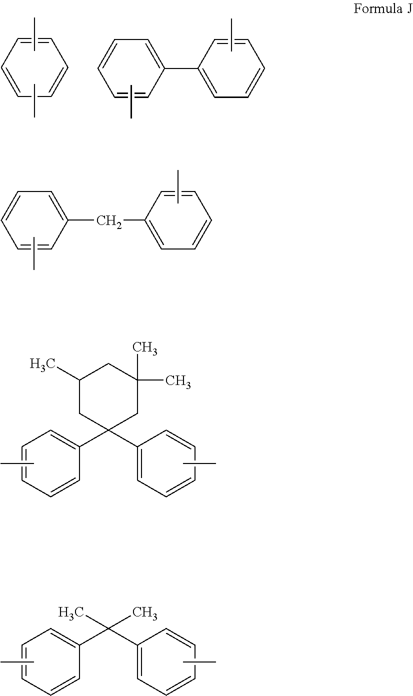

wherein the monophenylene and bisphenol-A groups can be specifically mentioned.

In these aspects, each of R¹⁶, R¹⁷, R¹⁸, and R¹⁹ can be aromatic, i.e., phenyl, n is 1, and p is 1-5, specifically 1-2. In some aspects at least one of R¹⁶, R¹⁷, R¹⁸, R¹⁹, and X corresponds to a monomer, e.g., bisphenol-A or resorcinol. In another aspect, X may be derived especially from resorcinol, hydroquinone, bisphenol-A, or diphenylphenol, and R¹⁶, R¹⁷, R¹⁸, R¹⁹, is aromatic, specifically phenyl. A specific aromatic organophosphorus compound of this type is resorcinol bis(diphenyl phosphate), also known as RDP. Another specific class of aromatic organophosphorus compounds having two or more phosphorus-containing groups are compounds of Formula K:

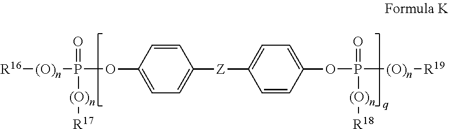

wherein R¹⁶, R¹⁷, R¹⁸, R¹⁹, n, and q are as defined for Formula I and wherein Z is C₁₋₇ alkylidene, C₁₋₇ alkylene, C₅₋₁₂ cycloalkylidene, —O—, —S—, —SO₂—, or —CO—, specifically isopropylidene. A specific aromatic organophosphorus compound of this type is bisphenol-A bis(diphenyl phosphate), also known as BPADP, wherein R¹⁶, R¹⁷, R¹⁸, and R¹⁹ are each phenyl, each n is 1, and q is from 1 to 5, from 1 to 2, or 1.

In further aspects, R¹⁶, R¹⁷, R¹⁸, and R¹⁹ can be alkyl substituted aromatic moieties. Historically the benefit of these organophosphorus compounds is the flexible compounding (as they are solid organophosphorus compounds). More importantly however, aromatic organophosphorus compounds exhibit increased (chemical) hydro-stability as a consequence of the steric protection of the phosphonate functionality.

Organophosphorus flame retardant species containing at least one phosphorus-nitrogen bond are also useful as the flame retardant species of the coupler component. These flame retardant species may include phosphazenes, phosphorus ester amides, phosphoric acid amides, phosphonic acid amides, phosphinic acid amides, and tris(aziridinyl) phosphine oxide. Phosphazenes (Formula L) and cyclic phosphazenes (Formula M)

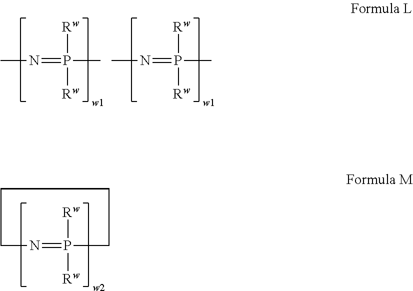

in particular can used, wherein w1 is 3 to 10,000 and w2 is 3 to 25, specifically 3 to 7, and each R^{w} is independently a C₁₋₁₂ alkyl, alkenyl, alkoxy, aryl, aryloxy, or polyoxyalkylene group. In the foregoing groups at least one hydrogen atom of these groups can be substituted with a group having an N, S, O, or F atom, or an amino group. For example, each R^{w} can be a substituted or unsubstituted phenoxy, an amino, or a polyoxyalkylene group. Any given R^{w} can further be a cross-link to another phosphazene group. Exemplary cross-links include bisphenol groups, for example bisphenol A groups. Examples include phenoxy cyclotriphosphazene, octaphenoxy cyclotetraphosphazene decaphenoxy cyclopentaphosphazene, and the like. A combination of different phosphazenes can be used.

The coupler component comprising a flame retardant species may include a functionalized organobromine compound including polymeric organobromine compounds. In some aspects the coupler component comprising a flame retardant species comprises a tetrabromobisphenol A compound. In particular aspects the coupler component comprising a flame retardant species comprises tetrabromobisphenol A-tetrabromobisphenol A diglycidyl ether, an epoxy functionalized bromo-polyacrylate or polyacrylate copolymer or an epoxy functionalized brominated polystyrene copolymer. In a specific aspect, the coupler component comprises a tetrabromobisphenol A/2,2-Bis-[4-(2,3-epoxypropoxy)-dibromophenyl]-propane copolymer. Particular examples of suitable coupler components comprising a flame retardant species include, but are not limited to, the following:

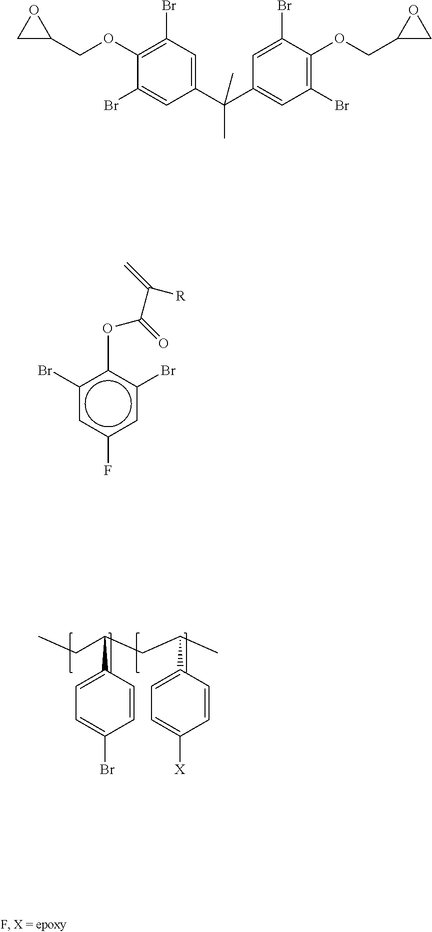

The coupler component may be present as a percentage of the total weight of the composition. In some aspects, the coupler component comprising at least two epoxy groups may be present in an amount of up to about 20 wt %, or from 1 wt % to about 15 wt %. For example, the coupler component may be present in an amount of about 1, 2, 3, 4, 5, 6, 7, 8, 9, or about 10 wt %. In one aspect, the coupler component may be present in an amount of about 10 wt %.

In an aspect, the pre-dynamic polymer composition may further include a coupler component which functions as an additional networking additive. An exemplary additional coupler component may comprise D.E.R.™ 671 (described above) in addition to the networking organophosphorus epoxy coupler.

In certain aspects, a synergist may be included in the pre-dynamic cross-linked polymer composition (and/or the synthesis thereof) to supplement the modified epoxy coupler component comprising a flame retardant species. The flame retardant species of the coupler component may be accompanied by a synergist, particularly inorganic antimony compounds. Exemplary inorganic synergist compounds include antimony pentoxide Sb₂O₅, antimony trisulfide SbS₃, sodium antimonate and the like. A particular synergist may comprise antimony trioxide (Sb₂O₃). The flame retardant synergist may be present in an amount of up to 15 wt %, up to 10 wt %, or up to 4 wt %. In one example, the flame retardant synergist may be present at 4 wt % or about 4 wt %.

A pre-dynamic cross-linked polymer composition formed from the flame retardant species modified coupler component may exhibit certain flame properties upon sufficient curing of the pre-dynamic cross-linked polymer composition. As an example, the dynamic cross-linked polymer composition formed may exhibit a V0 flame rating at 0.8 millimeter (mm) measured according to UL 94 (2014) with a flame out time (t-FOT) of up to about 10 seconds. In a further example, the dynamic cross-linked polymer composition may exhibit a V0 flame rating at 0.4 mm measured according to UL 94 (2014) with a flame out time (t-FOT) of up to about 10 seconds.

### Catalysts

As provided herein, the pre-dynamic cross-linked polymer composition may, in some aspects comprise one or more catalysts. The polyester component, coupler component, and non-networking component may be reacted in the presence of one or more suitable catalysts. Certain catalysts may be used to catalyze the reactions described herein. One or more catalysts may be used herein to facilitate the formation of a network throughout the compositions disclosed. In one aspect, a catalyst may be used to facilitate the ring opening reaction of epoxy groups of the coupler component with the carboxylic acid end-group of the polyester (or chain) component. This reaction effectively results in chain extension and growth of the ester oligomer component via condensation, as well as to the in-situ formation of additional alcohol groups along the oligomeric backbone of the ester oligomer component. Furthermore, such a catalyst may subsequently facilitate the reaction of the generated alcohol groups with the ester groups of the polyester (or chain) component (a process called transesterification), leading to network formation. When such a catalyst remains active, and when free alcohol groups are available in the resulting network, the continuous process of transesterification reactions leads to a dynamic polymer network.

As described herein, a catalyst may be considered a transesterification catalyst, a polycondensation catalyst, or in some instances, both. In various aspects, some catalysts may function as both a transesterification catalyst and a polycondensation catalyst. Although certain catalysts may be sufficient for use as both a transesterification and a polycondensation catalyst, for simplification, the following description details certain aspects of the transesterification catalyst and the polycondensation catalyst separately. It is understood that such separation and description is intended for example only and is not intended to be limiting regarding the user of various catalysts in various aspects of the processes described herein.

### Transesterification Catalyst

An example catalyst, as described herein, may be considered a transesterification catalyst. Generally, a transesterification catalyst facilitates the exchange of an alkoxy group of an ester by another alcohol. The transesterification catalyst as used herein facilitates reaction of free alcohol groups with ester groups in the backbone of the polyester (or chain) component or its final dynamic polymer network. As provided herein, these free alcohol groups are generated in-situ in a previous step by the ring-opening reaction of the epoxy chain extender with the carboxylic acid end-groups of the ester oligomer component. Certain transesterification catalysts are known in the art and are usually chosen from metal salts, for example, acetylacetonates, of zinc, tin, magnesium, cobalt, calcium, titanium, and zirconium. In certain aspects, the transesterification catalyst(s) may be used in an amount up to 25 wt % or up to about 25 wt %, for example, 0.001 wt % to 25 wt % or about 0.001 wt % to about 25 wt %, of the total molar amount of ester groups in the ester oligomer component. In some aspects, the transesterification catalyst is used in an amount of from about 0.001 wt % to 10 wt % or about 0.001 wt % to about 10 wt % or from 0.001 wt % to about 5 wt % or about 0.001 wt % to about 5 wt %. Preferred aspects include 0.001 wt % or about 0.001 wt %, 0.05 wt % or about 0.05 wt %, 0.1 wt % or about 0.1 wt %, and 0.2 wt % or about 0.2 wt % of catalyst, based on the number of ester groups in the ester oligomer component.

Suitable transesterification catalysts are also described in Otera, J. Chem. Rev. 1993, 93, 1449-1470, the disclosure of which is incorporated herein by this reference in its entirety. Tests for determining whether a catalyst will be appropriate for a given polymer system within the scope of the disclosure are described in, for example, U.S. Published Application No. 2011/0319524 and in WO 2014/086974, the disclosures of which are incorporated herein by this reference in their entirety.

Tin compounds such as dibutyltinlaurate, tin octanoate, dibutyltin oxide, dioctyltin, dibutyldimethoxytin, tetraphenyltin, tetrabutyl-2,3-dichlorodistannoxane, and all other stannoxanes are suitable catalysts. Rare earth salts of alkali metals and alkaline earth metals, particularly rare earth acetates, alkali metal and alkaline earth metals such as calcium acetate, zinc acetate, tin acetate, cobalt acetate, nickel acetate, lead acetate, lithium acetate, manganese acetate, sodium acetate, and cerium acetate are other catalysts that can be used. Salts of saturated or unsaturated fatty acids and metals, alkali metals, alkaline earth and rare earth metals, for example zinc stearate, are also suitable catalysts. The catalyst may also be an organic compound, such as benzyldimethylamide or benzyltrimethylammonium chloride. These catalysts are generally in solid form, and advantageously in the form of a finely divided powder. Exemplary catalysts include zinc(II)acetylacetonate or zinc(II)acetate. Another exemplary catalyst is aluminum phosphonate.

### Polycondensation Catalyst

In some aspects, the compositions of the present disclosure are prepared using a polycondensation catalyst. The polycondensation catalyst may increase the polymer chain length (and molecular weight) by facilitating the condensation reaction between alcohol and carboxylic acid end-groups of the ester oligomer component in an esterification reaction. Alternatively, this catalyst may facilitate the ring opening reaction of the reactive (e.g., epoxy) groups in the coupler component with the carboxylic acid end-groups of the ester oligomer component. The polycondensation catalyst is used in an amount of between 10 parts per million (ppm) and 100 ppm with respect to the ester groups in the ester oligomer component. In some aspects, the polycondensation catalyst is used in an amount of from 10 ppm to 100 ppm or from 10 ppm to less than 75 ppm. Preferred aspects include 20 ppm, 30 ppm, 50 ppm of catalyst, based on the polyester component of the present disclosure. In a preferred aspect, the polycondensation catalyst is used in an amount of about 50 ppm or 50 ppm or 0.005 wt % about 0.005 wt %.

Various titanium (Ti) based compounds have been proposed as polycondensation catalysts, because they are relatively inexpensive and safe. Described titanium-based catalysts include tetra-n-propyl titanate, tetraisopropyl titanate, tetra-n-butyl titanate, tetraphenyl titanate, tetracyclohexyl titanate, tetrabenzyl titanate, tetra-n-butyl titanate tetramer, titanium acetate, titanium glycolates, titanium oxalates, sodium or potassium titanates, titanium halides, titanate hexafluorides of potassium, manganese and ammonium, titanium acetylacetate, titanium alkoxides, titanate phosphites etc. The use of titanium based polycondensation catalysts in the production of polyesters has been described in EP0699700, U.S. Pat. No. 3,962,189, JP52062398, U.S. Pat. Nos. 6,372,879, and 6,143,837, for example. The disclosures of these publications are incorporated herein by this reference in their entirety. An exemplary titanium based polycondensation catalyst of the present disclosure is titanium(IV) isopropoxide, also known as tetraisopropyl titanate.

Other transesterification or polycondensation catalysts that can be used include metal oxides such as zinc oxide, antimony oxide, and indium oxide; metal alkoxides such as titanium tetrabutoxide, titanium propoxide, titanium isopropoxide, titanium ethoxide, zirconium alkoxides, niobium alkoxides, tantalum alkoxides; alkali metals; alkaline earth metals, rare earth alcoholates and metal hydroxides, for example sodium alcoholate, sodium methoxide, potassium alkoxide, and lithium alkoxide; sulfonic acids such as sulfuric acid, methane sulfonic acid, paratoluene sulfonic acid; phosphines such as triphenylphosphine, dimethylphenylphosphine, methyldiphenylphosphine, triterbutylphosphine; phosphazenes, and combinations thereof.

### Additives

One or more additives may be combined with the components of the dynamic or pre-dynamic cross-linked polymer to impart certain properties to the polymer composition. Exemplary additives include: one or more polymers, ultraviolet agents, ultraviolet stabilizers, heat stabilizers, antistatic agents, anti-microbial agents, anti-drip agents, radiation stabilizers, pigments, dyes, fibers, fillers, plasticizers, fibers, additional flame retardants, antioxidants, lubricants, impact modifiers, wood, glass, and metals, and combinations thereof. In further aspects the composition does not include an additional flame retardant component (e.g., a non-networking flame retardant) other than the flame retardant species included in the coupler component; in other words the only flame retardant component in the composition is the flame retardant species included in the coupler component. In particular, in some aspects the composition does not include a halogenated flame retardant component.

In certain aspects, a synergist may be included in the pre-dynamic cross-linked polymer composition to supplement the modified epoxy coupler component comprising a flame retardant species.

The compositions described herein may comprise an ultraviolet (UV) stabilizer for dispersing UV radiation energy. The UV stabilizer does not substantially hinder or prevent cross-linking of the various components of the compositions described herein. UV stabilizers may be hydroxybenzophenones, hydroxyphenyl benzotriazoles, cyanoacrylates, oxanilides, or hydroxyphenyl triazines. The compositions described herein may comprise heat stabilizers. Exemplary heat stabilizer additives include, for example, organophosphites such as triphenyl phosphite, tris-(2,6-dimethylphenyl)phosphite, tris-(mixed mono-and di-nonylphenyl)phosphite or the like; phosphonates such as dimethylbenzene phosphonate or the like; phosphates such as trimethyl phosphate, or the like; or combinations thereof.

The compositions described herein may comprise an antistatic agent. Examples of monomeric antistatic agents may include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

The compositions described herein may comprise anti-drip agents. The anti-drip agent may be a fibril forming or non-fibril forming fluoropolymer such as polytetrafluoroethylene (PTFE). The anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. An exemplary TSAN can comprise 50 wt % (or about 50 wt %) PTFE and 50 wt % (or about 50 wt %) SAN, based on the total weight of the encapsulated fluoropolymer. The SAN can comprise, for example, 75 wt % (or about 75 wt %) styrene and 25 wt % (or about 25 wt %) acrylonitrile based on the total weight of the copolymer. A SAN may comprise, e.g., from 50 wt % to 99 wt %, or from about 50 wt % to 99 wt %, styrene, and from 1 wt % to 50 wt % or from about 1 wt % to about 50 wt % acrylonitrile, including all intermediate values. Alternatively, the fluoropolymer can be pre-blended in some manner with a second polymer, such as for, example, an aromatic polycarbonate or SAN to form an agglomerated material for use as an anti-drip agent. Either method can be used to produce an encapsulated fluoropolymer.

Exemplary fibers include glass fibers, carbon fibers, polyester fibers, polyamide fibers, aramid fibers, cellulose and nanocellulose fibers or plant fibers (linseed, hemp, sisal, bamboo, etc.) may also be envisaged. In some aspects, the pre-dynamic cross-linked compositions described herein may comprise a glass fiber filler or other fiber filler. The glass fiber filler may have a diameter of 1-25 micrometers (μm) or about 1 μm to about 25 μm and all intermediate values.

Suitable fillers for the compositions described herein include: silica, clays, calcium carbonate, carbon black, kaolin, and whiskers. Other possible fillers include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as titanium dioxide TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

Plasticizers, lubricants, and mold release agents can be included. A mold release agent (MRA) allows the material to be removed quickly and effectively. Mold releases can reduce cycle times, defects, and browning of finished product. There is a considerable overlap among these types of materials, which may include, for example, phthalic acid esters; tristearin; di- or polyfunctional aromatic phosphates; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like.

Exemplary antioxidant additives include organophosphites such as tris(nonyl phenyl)phosphite, tris(2,4-di-t-butylphenyl)phosphite (“Irgafos™ 168” or “I-168”), bis(2,4-di-t-butylphenyl)pentaerythritol diphosphite, distearyl pentaerythritol diphosphite, tris(dialkylaryl)phosphite, e.g., tris(di-t-butylphenyl)phosphite or tris(di-t-amylphenyl)phosphite, and the bis(dialkylaryl)monoalkylaryl phosphite, e.g., bis(di-t-butylphenyl)mono-t-butylphenyl phosphite or bis(di-t-amylphenyl)mono-t-amylphenyl phosphite, or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

### Articles and Processes

Articles can be formed from the compositions described herein. Generally, the ester oligomer component, the monomeric chain extender, and the transesterification and polycondensation catalysts are combined and heated to provide a molten mixture which is reacted under decreased pressure to form the dynamic cross-linked compositions described herein. The compositions described herein can then form, shaped, molded, or extruded into a desired shape. The term “article” refers to the compositions described herein being formed into a particular shape. As an example, articles may be formed from the dynamic cross-linked polymer compositions of the present disclosure and may include composites, a thermoformed material, or a combination thereof. The articles may further comprise a solder bonded to the formed article. It is understood that such examples are not intended to be limiting, but are illustrative in nature. It is understood that the subject compositions may be used for various articles and end-use applications.

With thermosetting resins of the prior art, once the resin has hardened (i.e. reached or exceeded the gel point), the article can no longer be transformed or repaired or recycled. Applying a moderate temperature to such an article does not lead to any observable or measurable transformation, and the application of a very high temperature leads to degradation of this article. In contrast, articles formed from the dynamic cross-linked polymer compositions described herein, on account of their particular composition, can be transformed, repaired, or recycled by raising the temperature of the article.

From a practical point of view, this means that over a broad temperature range, the article can be deformed, with internal constraints being removed at higher temperatures. Without being bound by theory, it is believed that transesterification exchanges in the dynamic cross-linked polymer compositions are the cause of the relaxation of constraints and of the variation in viscosity at high temperatures. In terms of application, these materials can be treated at high temperatures, where a low viscosity allows injection or molding in a press. It should be noted that, contrary to Diels-Alder reactions, no depolymerization is observed at high temperatures and the material conserves its cross-linked structure. This property allows the repair of two parts of an article. No mold is necessary to maintain the shape of the components during the repair process at high temperatures. Similarly, components can be transformed by application of a mechanical force to only one part of an article without the need for a mold, since the material does not flow.

Raising the temperature of the article can be performed by any known means such as heating by conduction, convection, induction, spot heating, infrared, microwave or radiant heating. Devices for increasing the temperature of the article in order to perform the processes of described herein can include: an oven, a microwave oven, a heating resistance, a flame, an exothermic chemical reaction, a laser beam, a hot iron, a hot-air gun, an ultrasonication tank, a heating punch, etc. The temperature increase can be performed in discrete stages, with their duration adapted to the expected result.

Although the dynamic cross-linked polymer compositions do not flow during the transformation, by means of the transesterification reactions, by selecting an appropriate temperature, heating time and cooling conditions, the new shape may be free of any residual internal constraints. The newly shaped dynamic cross-linked polymer compositions are thus not embrittled or fractured by the application of the mechanical force. Furthermore, the article will not return to its original shape. Specifically, the transesterification reactions that take place at high temperature promote a reorganization of the cross-link points of the polymer network so as to remove any stresses caused by application of the mechanical force. A sufficient heating time makes it possible to completely cancel these stresses internal to the material that have been caused by the application of the external mechanical force. This makes it possible to obtain stable complex shapes, which are difficult or even impossible to obtain by molding, by starting with simpler elemental shapes and applying mechanical force to obtain the desired more complex final shape. Notably, it is very difficult to obtain by molding shapes resulting from twisting. An article made from a dynamic cross-linked polymer composition can be heated and deformed, and upon returning to the original temperature, maintains the deformed shape. As such, articles in accordance with the present disclosure may comprise a shape generated by applying mechanical forces to a molded piece formed from the dynamic cross-linked polymer composition.

According to one variant, a process for obtaining and/or repairing an article based on a dynamic cross-linked polymer composition described herein comprises: placing in contact with each other two articles formed from a dynamic cross-linked polymer composition; and heating the two articles so as to obtain a single article. The heating temperature (T) is generally within the range from 50° C. to 250° C., including from 100° C. to 200° C.

An article made of dynamic cross-linked polymer compositions as described herein may also be recycled by direct treatment of the article, for example, the broken or damaged article is repaired by means of a transformation process as described above and may thus regain its prior working function or another function. Alternatively, the article is reduced to particles by application of mechanical grinding, and the particles thus obtained may then be used to manufacture a new article.

Pre-dynamic and dynamic cross-linked compositions of the present disclosure are useful in soldering applications. For example, the disclosed compositions may be used in workpieces that comprise a solder bonded to at least one component comprising a dynamic cross-linked polymer composition.

As used herein, the term “solder” may refer to a fusible metal composition, such an alloy, that is used to join one or more components to one another. Solders can be lead-based solders. Preferred lead-based solders comprise tin and lead. Typically, such solders comprise between 30 wt % and 95 wt %, or between about 30 wt % and about 95 wt %, of lead. Solders used in the disclosure can alternatively be lead-free solders. Lead-free solders can comprise tin, copper, silver, bismuth, indium, zinc, antimony, or a combination thereof. Preferred lead-free solders comprise tin, silver, and copper. Other solders useful in the present disclosure include those comprising tin, zinc, and copper; lead, tin, and antimony; tin, lead, and zinc; tin, lead, and zinc; tin, lead, and copper; tin, lead, and phosphorous; tin, lead, and copper; and lead, tin, and silver. As used herein, lead-free may be defined according to the Restriction of Hazardous Substances in Electrical and Electronic Equipment (RoHS) Directive (2002/95/EC) which provides that lead content is less than 0.1 wt % in accordance with IPC/EIA J-STD-006.

The following examples are provided to illustrate the compositions, processes, and properties of the present disclosure. The examples are merely illustrative and are not intended to limit the disclosure to the materials, conditions, or process parameters set forth therein.

### Aspects of the Disclosure

In various aspects, the present disclosure pertains to and includes at least the following aspects.

Aspect 1A: A composition, comprising: a polymer component comprising a pre-dynamic cross-linked polymer composition, wherein the pre-dynamic polymer composition comprises polyester component chains joined by a coupler component, the coupler component comprising a flame retardant species.

Aspect 1B: A composition, consisting of: a polymer component comprising a pre-dynamic cross-linked polymer composition, wherein the pre-dynamic polymer composition comprises polyester component chains joined by a coupler component, the coupler component comprising a flame retardant species.

Aspect 1C: A composition, consisting essentially of: a polymer component comprising a pre-dynamic cross-linked polymer composition, wherein the pre-dynamic polymer composition comprises polyester component chains joined by a coupler component, the coupler component comprising a flame retardant species.

Aspect 2: The composition of any of Aspects 1A-1C, wherein the pre-dynamic cross-linked polymer composition is produced by reacting at least the coupler component with the polyester component in the presence of one or more catalysts, the coupler component (a) comprising at least two epoxy groups, (b) comprising at least two anhydride groups, (c) comprising a glycerol or a glycerol derivative, or any of (a), (b), or (c).

Aspect 3: The composition of any of Aspects 1A-2, wherein the composition comprises from about 2 wt % to about 20 wt % of the coupler component.

Aspect 4: The composition of any of Aspects 1A-3, wherein the composition comprises up to about 15 wt % of the epoxy component.

Aspect 5: The composition of any of Aspects 1A-4, wherein the coupler component comprises an epoxy functionalized organo-bromine compound or an epoxy functionalized organophosphorus compound.

Aspect 6: The composition of Aspect 5, wherein the organophosphorus compound comprises a phosphazene.

Aspect 7: The composition of any of Aspects 1A-6, wherein the composition comprises a fiber dispersed within the composition.

Aspect 8: The composition of any of Aspects 1A-7, wherein the composition, when subjected to a curing process, forms a dynamic cross-linked polymer composition that (a) has a plateau modulus of from about 0.01 MPa to about 1000 MPa when measured by dynamic mechanical analysis at a temperature above the melting temperature of the polyester component of the dynamic cross-linked composition and (b) exhibits a capability of relaxing internal residual stresses at a characteristic timescale of between 0.1 and 100,000 seconds above the glass transition temperature of the polyester component, as measured by stress-relaxation rheology measurement.

Aspect 9: The composition of Aspect 8, wherein the curing process comprises heating the pre-dynamic cross-linked composition to a temperature of from about 170° C. to about 250° C. for up to about 8 hours, or the curing process comprises heating the pre-dynamic cross-linked composition to a temperature of from a temperature that corresponds to a glass transition temperature (Tg) of the composition to a temperature of about 250° C. for up to about 8 hours.

Aspect 10: The composition of any one of Aspects 1A-9, wherein the dynamic cross-linked polymer composition exhibits a V0 flame rating at 0.8 mm measured according to UL 94 (2014) with a flame out time (t-FOT) of up to about 10 seconds.

Aspect 11: The composition of any one of Aspects 1A-9, wherein the dynamically cross-linked polymer composition exhibits a V0 flame rating at 0.4 mm measured according to UL 94 (2014) with a flame out time (t-FOT) of up to about 10 seconds.

Aspect 12: The composition of any of Aspects 1A-11, wherein the composition does not include an additional flame retardant component other than the flame retardant species of the coupler component.

Aspect 13: An article comprising the dynamic cross-linked polymer composition of any of Aspects 1A-12, wherein the article has an MSL1 Classification according to IPC/JEDEC J-STD-020E for Moisture/Reflow Sensitivity Classification for Non-hermetic Surface Mount Devices.

Aspect 14: A method of forming an article that comprises a pre-dynamic cross-linked polymer composition, comprising: preparing a pre-dynamic cross-linked polymer composition according to any of Aspects 1A-13; and subjecting the pre-dynamic cross-linked polymer composition to a compression molding process, a profile extrusion process, or a blow molding process so as to form the article.

Aspect 15: A method of preparing a dynamic cross-linked polymer composition, the method comprising, or consisting of, or consisting essentially of:

reacting a coupler component comprising at least two reactive groups and a flame retardant species with a chain component comprising a polyester;

the reacting being performed under such conditions so as to form a pre-dynamic cross-linked composition,

the reacting being performed in the presence of at least one catalyst that promotes formation of the pre-dynamic cross-linked composition; and

the pre-dynamic cross-linked composition when subjected to a curing process (a) exhibits a plateau modulus of from about 0.01 MPa to about 1000 MPa when measured by dynamic mechanical analysis at a temperature above the melting temperature of the polyester component of the pre-dynamic cross-linked composition and (b) exhibits a capability of relaxing internal residual stresses at a characteristic timescale of between 0.1 and 100,000 seconds above the glass transition temperature of the polyester, as measured by stress-relaxation rheology measurement.

Aspect 16: The method of Aspect 15, wherein the curing process comprises heating the pre-dynamic cross-linked composition to a temperature of from about 170° C. to about 250° C. for up to about 8 hours, or the curing process comprises heating the pre-dynamic cross-linked composition to a temperature of from a temperature that corresponds to a glass transition temperature (Tg) of the composition to a temperature of about 250° C. for up to about 8 hours.

Aspect 17: The method of any of Aspects 15-16, wherein the reacting occurs at a temperature at which the polyester component is in a melted state.

Aspect 18: The method of any of Aspects 15-17, wherein the reacting occurs for fewer than about 15 minutes.

Aspect 19: The method of any of Aspects 15-18, wherein the at least one catalyst facilitates one or more of transesterification and polycondensation.

Aspect 20: The method of any of Aspects 15-19, further comprising including a fiber component into the pre-dynamic cross-linked composition.

Aspect 21: The method of any of Aspects 15-20, wherein the dynamic cross-linked polymer composition does not include an additional flame retardant component other than the flame retardant species of the coupler component.

Aspect 22: The composition of any one of Aspects 1A-12, wherein the coupler component comprises a tetrabromobisphenol A compound as the flame retardant species.

Aspect 23: The method of any one of Aspects 15-21, wherein the coupler component comprises a tetrabromobisphenol A compound as the flame retardant species.

### EXAMPLES

### Materials

PBT315 (molecular weight 110,000) (SABIC), milled
D.E.R.™ 671 (a solid epoxy resin that is the reaction product of epichlorohydrin and bisphenol A) (Dow Benelux B.V.)
Zinc(II)acetylacetonate (H₂O) (Acros)
Brominated Epoxy 1 (Tetrabromobisphenol A/2,2-Bis-[4-(2,3-epoxypropoxy)-dibromophenyl]-propane copolymer; (NF-300VLG from Alteco (68928-70-1))
Brominated Epoxy 2 (D.E.R.™ 560; a solid epoxy resin of the tetrabromobisphenol A epichlorohydrin type)
Poly(pentabromobenzylacrylate) (brominated flame retardant) Antimony trioxide, Sb₂O₃ (flame retardant synergist, master batch MB—80 wt % in PBT195; PBT195 (polybutylene terephthalate) (molecular weight 60,000) (SABIC)), milled
Exolit™ OP 1240 Aluminum phosphinate (catalyst for DCN formation)
Ultranox™ 1010 (an antioxidant) (BASF)
Zinc(II)acetylacetonate (Zn(AcAc)₂, H₂O) (Acros)
Polyethylene (release agent)
Tris(di-t-butylphenyl)phosphite (processing aid/stabilizer)
Polyethylene tetrastearate (PETS, >90% esterified)
Glass fiber (10 micrometer diameter, μm)

### Formation of Pre-Dynamic Cross-Linked Polymer and Dynamically Cross-Linked Compositions

The foregoing materials were used to prepare pre-dynamic compositions. The various combinations shown in Table 1 were compounded using a Werner & Pfleiderer Extruder ZSK 25 mm co-rotating twin-screw extruder with a melt temperature of 280° C., an output of 20 kilograms per hour (kg/h), and 300 revolutions per minute (rpm). The residence time in the extruder was less than 30 seconds. After reactive extrusion (compounding) of these formulations, the pre-dynamic cross-linked polymer compound pellets were either post-cured and then re-compounded in a second step with the second polymer resin of choice to form DCN blends or directly molded into parts and subsequently post-cured. In this case, all the epoxy groups have reacted away to form the DCN network, though it is not a requirement that all reactive groups of the coupler component be reacted. The completely cured pellets can be re-compounded with additional PBT. A portion of each sample was post-cured to form the fully dynamic cross-linked compositions as described herein. Post-curing was performed by heating the sample a temperature close to, but below, the melting temperature (Tₘ) of the polyester component. The post-curing temperatures used were 190° C. or 200° C. for the PBT-DCN samples. It is noted that the melting points for the PBT used in this illustrative example was 223° C. The post-cured granulates obtained adhered to each other, but could be separated with minimal force.

Flammability tests were performed following the procedure of Underwriter's Laboratory Bulletin 94 entitled “Tests for Flammability of Plastic Materials, UL 94”. Several ratings can be applied based on the rate of burning, time to extinguish, ability to resist dripping, and whether or not drips are burning. Bar thicknesses were 0.8 mm or 1 mm. Materials can be classified according to this procedure as UL 94 HB (horizontal burn), V0, V1, V2, 5VA and/or 5VB on the basis of the test results obtained for five samples; however, the compositions herein were tested and classified only as V0, V1, and V2, the criteria for each of which are described below. These criteria are dependent upon flame out times (FOTs) and are sensitive to dripping of the molten sample. If the molten sample does not ignite underlying cotton wool (i.e., a non-burning drip, “NB”), it does not affect the flammability rating. Where the molten burning sample does ignite the underlying cotton wool, it is indicated as a burning drip (BD). Individual flame out times of five bars tested with a FOT of 30 seconds or fewer receive a UL94-V1 or UL94-V2 rating. Individual FOTs of fewer than 10 seconds obtain a UL94-V0 rating.

V0: In a sample placed so that its long axis is 180 degrees to the flame, the period of flaming and/or smoldering after removing the igniting flame does not exceed ten (10) seconds and the vertically placed sample produces no drips of burning particles that ignite absorbent cotton. Five bar flame out time is the flame out time for five bars, each lit twice, in which the sum of time to flame out for the first (t1) and second (t2) ignitions is less than or equal to a maximum flame out time (t1+t2) of 50 seconds.

V1: In a sample placed so that its long axis is 180 degrees to the flame, the period of flaming and/or smoldering after removing the igniting flame does not exceed thirty (30) seconds and the vertically placed sample produces no drips of burning particles that ignite absorbent cotton. Five bar flame out time is the flame out time for five bars, each lit twice, in which the sum of time to flame out for the first (t1) and second (t2) ignitions is less than or equal to a maximum flame out time (t1+t2) of 250 seconds.

V2: In a sample placed so that its long axis is 180 degrees to the flame, the average period of flaming and/or smoldering after removing the igniting flame does not exceed thirty (30) seconds, but the vertically placed samples produce drips of burning particles that ignite cotton. Five bar flame out time is the flame out time for five bars, each lit twice, in which the sum of time to flame out for the first (t1) and second (t2) ignitions is less than or equal to a maximum flame out time (t1+t2) of 250 seconds.

Moisture Sensitivity Level (MSL) values, where provided, were obtained according to IPC/JEDEC J-STD-020 for Moisture/Reflow Sensitivity Classification for Non-hermetic Surface Mount Devices. Reflow soldering simulations for the example compositions for applicability as connector materials in lead-free reflow soldering were performed at SABIC's Application Technology facilities in Moka, Japan. A Malcom SRS-1C reflow simulator was used (manufactured by Malcom, Japan), where molded connector samples were subjected to a temperature profile for curing lead-free solder pastes. Prior to reflow soldering simulations, the molded and post-cured connectors were conditioned in a climate chamber using the sample conditioning profile as specified for MSL rating guidelines per IPC/JEDEC J-STD-020D (revision 2008) tests standards. The samples were evaluated for MSL 1. Visual inspection and measurements of warpage and shrinkage were used to assess the performance of each candidate material. A temperature humidity, or climate, chamber was used for conditioning of the test samples prior to testing by heat shock treatment or reflow soldering simulation. The chamber was capable of operating at 85° C./85% RH, 60° C./60% RH, and 23° C./50% RH. Within the chamber working area, temperature tolerance is ±2° C. and the RH tolerance is ±3% RH.

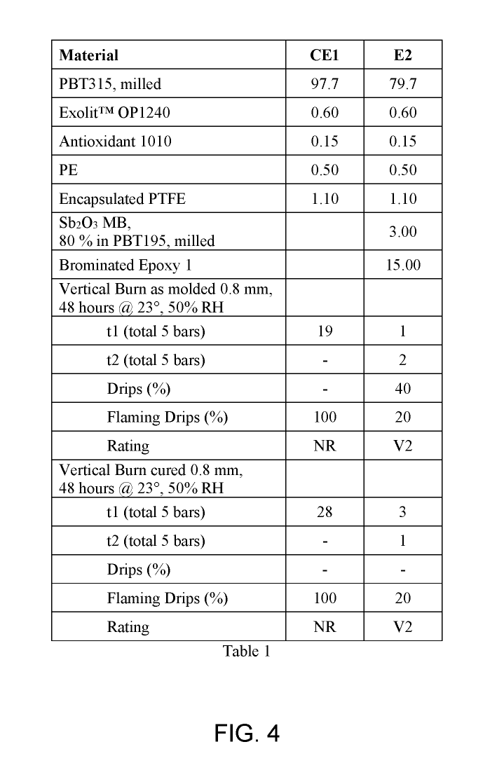

Table 1 as shown in FIG. 4 presents the formulations for comparative unfilled samples CE1 against inventive sample E1. Inventive sample E1 is a DCN composition formed with the coupler component including a flame retardant species (Brominated Epoxy 1).

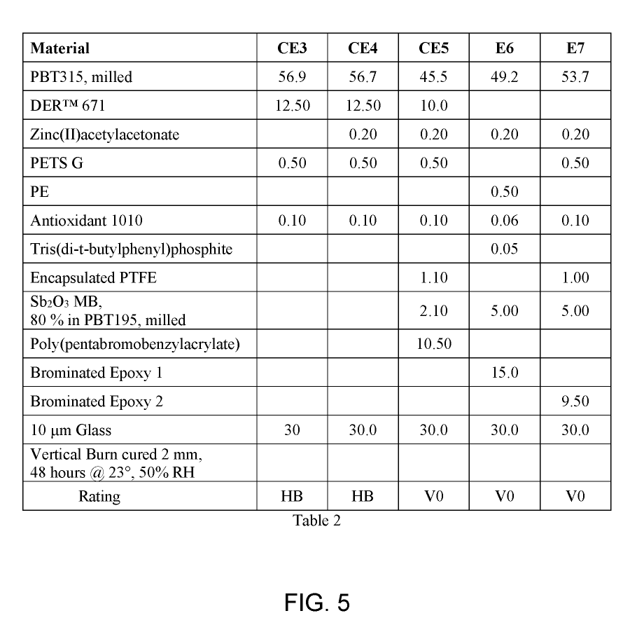

As shown in Table 1, the unfilled DCN formulation E2 exhibited a V2 flame rating compared to a NR for the dynamically cross-linked comparative sample DCN CE1, which does not contain a flame retardant. It is also noted that the amount of flaming drips is less for E2 as compared to CE1.Table 2 as shown in FIG. 5 provides data for comparative (CE4-6) and inventive (E6, E7) filled samples using two different brominated epoxies (Brominated Epoxy 1 and Brominated Epoxy 2). Vertical burn was tested on 2 mm samples. Comparative sample CE3 is a non-networking reference sample, which does not contain catalyst. Comparative sample CE4 is a networking example (DCN), but does not contain a networking flame retardant or an additional flame retardant. Comparative example CE5 is a DCN, which does not contain a network flame retardant, but a non-networking flame retardant (Poly(pentabromobenzylacrylate)

As shown in Table 2, DCN formulation E6 and E7 exhibited better flame retardant performance than the comparative examples CE3 and CE4, which do not contain a flame retardant, as indicated by the V0 rating of E6 and E7 and low flame out times. Comparative examples CE3 and CE4 exhibited a HB rating. DCN formulation E6 and E, which contain a networking FR agent, have similar performance as compared to the non-networking FR examples CE4.

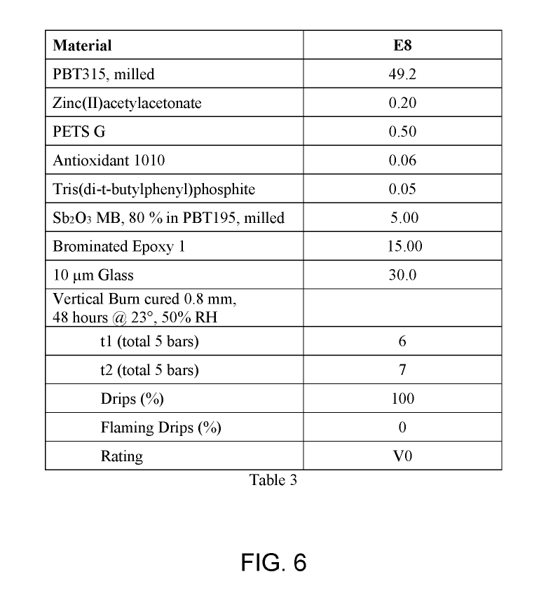

Table 3 as shown in FIG. 6 provides data for an inventive (E8) sample with 0.8 mm vertical burn results using Brominated Epoxy 1.

As shown from the data, 100% of the drips of the inventive composition were non-flaming and E8 exhibits a V0 performance at 0.8 mm thickness.

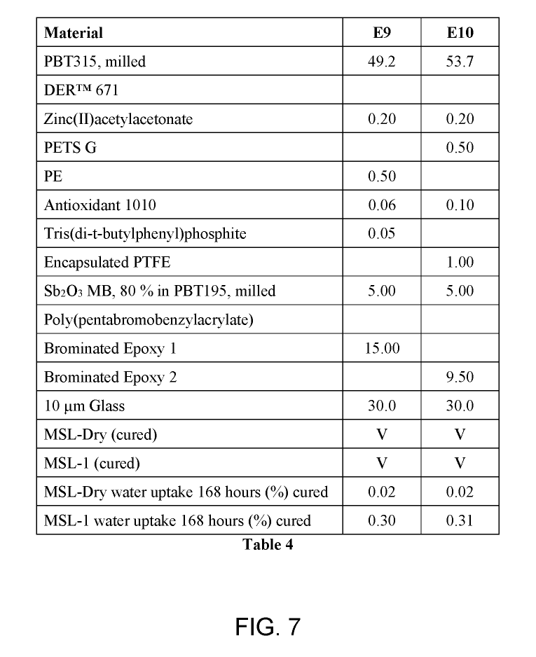

Table 4 as shown in FIG. 7 provides moisture sensitivity level data for inventive (E9, E10) samples using Brominated Epoxy 1 or Brominated Epoxy 2.

As shown from the data, both examples had a MSL level V (i.e., passing). The data in Table 6 shows that MSL-1 levels can be obtained for inventive compositions E9 and E10.

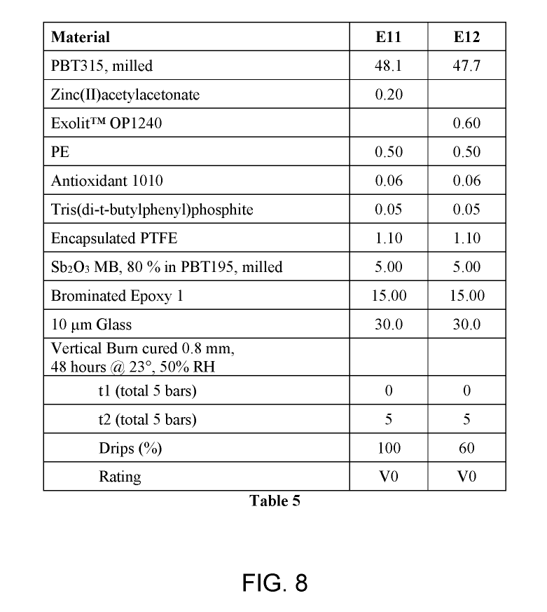

Table 5 as shown in FIG. 8 provides vertical burn data for inventive (E11, E12) samples including encapsulated PTFE and either zinc(II)acetylacetonate (E11) or Exolit OP1240 (E12) as a catalyst.

As shown from the data, the inclusion of encapsulated PTFE (E12) helped to reduce the amount of non-flaming drips (compared to E11), The data in Table 5 demonstrates that for both catalysts (zinc(II) acetylacetonate and Exolit OP1240), a V0 rating can be obtained at 0.8 mm.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical aspects have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A composition, comprising:
a polymer component comprising a pre-dynamic cross-linked polymer composition,
wherein the pre-dynamic polymer composition comprises polyester component chains joined by a coupler component, the coupler component comprising a flame retardant species.

2. The composition of claim 1, wherein the pre-dynamic cross-linked polymer composition is produced by reacting at least the coupler component with the polyester component in the presence of one or more catalysts, the coupler component (a) comprising at least two epoxy groups, (b) comprising at least two anhydride groups, (c) comprising a glycerol or a glycerol derivative, or any of (a), (b), or (c).

3. The composition of claim 1, wherein the composition comprises from about 2 wt % to about 20 wt % of the coupler component.

4. The composition of claim 1, wherein the composition comprises up to about 15 wt % of the epoxy component.

5. The composition of claim 1, wherein the coupler component comprises an epoxy functionalized organobromine compound or an epoxy functionalized organophosphorus compound.

6. The composition of claim 5, wherein the organophosphorus compound comprises a phosphazene.

7. The composition of claim 1, wherein the composition does not include an additional flame retardant component other than the flame retardant species of the coupler component.

8. The composition of claim 1, wherein the composition comprises a fiber dispersed within the composition.

9. The composition of claim 1, wherein the composition, when subjected to a curing process, forms a dynamic cross-linked polymer composition that (a) has a plateau modulus of from about 0.01 MPa to about 1000 MPa when measured by dynamic mechanical analysis at a temperature above the melting temperature of the polyester component of the dynamic cross-linked composition and (b) exhibits a capability of relaxing internal residual stresses at a characteristic timescale of between 0.1 and 100,000 seconds above the glass transition temperature of the polyester component, as measured by stress-relaxation rheology measurement.

10. The composition of claim 9, wherein the curing process comprises heating the pre-dynamic cross-linked composition to a temperature of from a temperature that corresponds to a glass transition temperature (Tg) of the composition to a temperature of about 250° C. for up to about 8 hours.

11. The composition of claim 1, wherein the dynamic cross-linked polymer composition exhibits a V0 flame rating at 0.8 mm measured according to UL 94 (2014) with a flame out time (t-FOT) of up to about 10 seconds.

12. The composition of claim 1, wherein the dynamically cross-linked polymer composition exhibits a V0 flame rating at 0.4 mm measured according to UL 94 (2014) with a flame out time (t-FOT) of up to about 10 seconds.

13. The composition of claim 1, wherein the coupler component comprises a tetrabromobisphenol A compound as the flame retardant species.

14. An article comprising the dynamic cross-linked polymer composition of claim 1, wherein the article has an MSL1 Classification according to IPC/JEDEC J-STD-020E for Moisture/Reflow Sensitivity Classification for Non-hermetic Surface Mount Devices.

15. A method of forming an article that comprises a pre-dynamic cross-linked polymer composition, comprising:
preparing a pre-dynamic cross-linked polymer composition according to claim 1; and
subjecting the pre-dynamic cross-linked polymer composition to a compression molding process, a profile extrusion process, or a blow molding process so as to form the article.

16. A method of preparing a dynamic cross-linked polymer composition, the method comprising:
reacting a coupler component comprising at least two reactive groups and a flame retardant species with a chain component comprising a polyester;
the reacting being performed under such conditions so as to form a pre-dynamic cross-linked composition,
the reacting being performed in the presence of at least one catalyst that promotes formation of the pre-dynamic cross-linked composition; and
the pre-dynamic cross-linked composition when subjected to a curing process (a) exhibits a plateau modulus of from about 0.01 MPa to about 1000 MPa when measured by dynamic mechanical analysis at a temperature above the melting temperature of the polyester component of the pre-dynamic cross-linked composition and (b) exhibits a capability of relaxing internal residual stresses at a characteristic timescale of between 0.1 and 100,000 seconds above the glass transition temperature of the polyester, as measured by stress-relaxation rheology measurement.

17. The method of claim 16, wherein the curing process comprises heating the pre-dynamic cross-linked composition to a temperature of from a temperature that corresponds to a glass transition temperature (Tg) of the composition to a temperature of about 250° C. for up to about 8 hours.

18. The method of claim 16, wherein the reacting occurs at a temperature at which the polyester component is in a melted state.

19. The method of claim 16, wherein the at least one catalyst facilitates one or more of transesterification and polycondensation.

20. The method of claim 16, further comprising including a fiber component into the pre-dynamic cross-linked composition.
